(19) United States
(12) Patent Application Publication
(10) Pub. No.: US 2024/0259734 A1
(43) Pub. Date: Aug. 1, 2024

(54) CAPACITIVE, MEMS-TYPE ACOUSTIC TRANSDUCER HAVING SEPARATE SENSITIVE AND TRANSDUCTION AREAS AND MANUFACTURING PROCESS THEREOF

(71) Applicant: STMICROELECTRONICS S.r.l., Agrate Brianza (IT)

(72) Inventors: Federico VERCESI, Milano (IT); Fabrizio CERINI, Magenta (IT); Silvia ADORNO, Novate Milanese (IT)

(73) Assignee: STMICROELECTRONICS S.r.l., Agrate Brianza (IT)

(21) Appl. No.: 18/416,751

(22) Filed: Jan. 18, 2024

(30) Foreign Application Priority Data
Jan. 26, 2023 (IT) 102023000001191

(51) Int. Cl. H04R 19/04; H04R 7/04; H04R 7/18; H04R 19/00; H04R 31/00

(52) U.S. Cl. CPC H04R 19/04; H04R 7/04; H04R 7/18; H04R 19/005; H04R 31/003; H04R 31/006; H04R 2201/003

(57) ABSTRACT

Capacitive, MEMS-type acoustic transducer, having a sound collection part and a transduction part. A substrate region surrounds a first chamber arranged in the sound collection part and open towards the outside; a fixed structure is coupled to the substrate region; a cap region is coupled to the fixed structure. A sensitive membrane is arranged in the sound collection part, is coupled to the fixed structure and faces the first chamber. A transduction chamber is arranged in the transduction part, hermetically closed with respect to the outside and accommodates a detection membrane. An articulated structure extends between the sensitive membrane and the detection membrane, through the walls of the transduction chamber. A fixed electrode faces and is capacitively coupled to the detection membrane. Conducive electrical connection regions extend above the substrate region, into the transduction chamber.

### BACKGROUND

### Technical Field

The present disclosure relates to a capacitive, MEMS-type acoustic transducer, having separate sensitive and transduction areas, and the manufacturing process thereof.

### Description of the Related Art

As is known, a capacitive-type acoustic transducer, in particular a MEMS microphone, comprises a micromechanical detection structure, formed in a die of semiconductor material, typically silicon, and including a movable electrode, formed as a diaphragm or membrane, facing a fixed electrode (also called “backplate”). The movable electrode and the fixed electrode thus form the plates of a variable-capacitance detection capacitor.

The movable electrode is anchored, for example at a peripheral portion thereof, to a fixed support part, while a portion thereof, for example a central portion, is free to move, bending, in response to the pressure exerted by the impinging sound waves. The bending of the membrane which forms the movable electrode causes a capacitance variation of the detection capacitor, which is a function of the acoustic signal to be detected and therefore causes an electrical signal correlated to the acoustic signal to be generated. However, there are noise sources, which worsen performance of the acoustic transducer.

Some solutions to resolve the problem of noise sources and to improve the sign-to-noise ratio have other drawbacks. Such as, requiring a SOI (Silicon On Insulator) substrate is expensive. Using a doped substrate is expensive and not suitable for alignment through infrared rays and does not allow for easy inspection (which is also usually done using infrared rays).

The final thickness of an articulated structure (transmissive system) is obtained by lapping, which does not always ensure the desired flexibility and smoothness; on the contrary, the surface is often rough, has grooves and grinding marks which are possible weak points from a mechanical point of view.

Bonding is done using a metal (for example AlGe) which requires relatively complex procedures translating into high costs and is not inspectable by ultrasound.

### BRIEF SUMMARY

According to the present disclosure, a capacitive, MEMS-type acoustic transducer and the manufacturing process thereof are provided.

An acoustic transducer, comprising: a sound collection part; a transduction part; a substrate region surrounding a first chamber in the sound collection part, the first chamber being in fluid communication with an external environment; a fixed structure coupled to the substrate region; a cap region coupled to the fixed structure; a sensitive membrane in the sound collection part, the sensitive membrane being coupled to the fixed structure and having a first face facing the first chamber; a transduction chamber in the transduction part, the transduction chamber being delimited by walls of the substrate region, the fixed structure and the cap region and being hermetically closed; a detection membrane in the transduction chamber, the detection membrane being between the substrate region and the fixed structure; an articulated structure extending in a first direction between the sensitive membrane and the detection membrane; at least one fixed electrode facing the detection membrane and capacitively coupled thereto; and conductive electrical connection regions in the transduction chamber and extending in a second direction, transverse the first direction, between the substrate region and the cap region, the conductive electrical connection regions being in selective electrical contact with the articulated structure and the at least one fixed electrode.

Methods of manufacturing the acoustic transducer are also provided.

### BRIEF DESCRIPTION OF THE SEVERAL VIEWS OF THE DRAWINGS

For a better understanding of the present disclosure, an embodiment thereof is now described, purely by way of a non-limiting example.

FIG. 1 is a schematic representation of a MEMS microphone;

FIG. 2 is a schematic representation of another MEMS microphone;

FIG. 3 is a cross-section of an embodiment of the present MEMS microphone, taken along section line III-III of FIG. 7;

FIG. 4 is a simplified perspective view of the general structure of the MEMS microphone of FIG. 3;

FIG. 5 is a top perspective view of a detail of the MEMS microphone of FIG. 3;

FIG. 6 is a top perspective view of another detail of the MEMS microphone of FIG. 3;

FIG. 7 is a schematic top view of the MEMS microphone of FIG. 3;

FIG. 8 is a schematic top view similar to FIG. 7, with parts removed, of the MEMS microphone of FIG. 3;

FIG. 9 is a cross-section, taken along section line IX-IX of FIG. 7, of a detail of the present MEMS microphone;

FIG. 10 is a bottom plan view of a portion of the wafer of FIG. 3; and

FIGS. 11-18 are cross-sections, similar to FIG. 3, of successive manufacturing steps of the MEMS microphone of FIG. 3.

### DETAILED DESCRIPTION

The following description refers to the arrangement shown; consequently, expressions such as “above,” “below,” “top,” “bottom,” “right,” “left” relate to the accompanying figures and are not to be interpreted in a limiting manner, except where explicitly indicated.

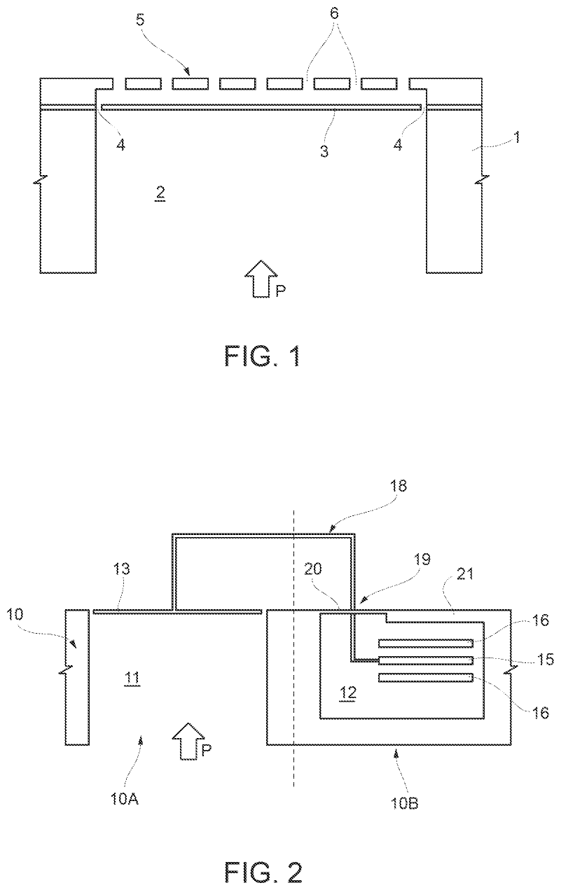

A simplified diagram of a detection structure of an acoustic transducer is shown, for example, in FIG. 1.

In FIG. 1, a semiconductor die 1 forms a chamber 2 open on one side (at the bottom, in FIG. 1) and delimited at the top by a membrane 3 provided with roll-off or ventilation holes 4 and capable of deforming in the presence of acoustic pressure (arrow P).

The membrane 3 faces a plate 5, also called “backplate”, and forms a fixed electrode. The plate 5 generally has a plurality of holes 6.

The membrane 3 and/or the plate 5 are connected to electronics (not shown) having the function of electrically biasing them, acquiring the capacitance variation signal and outputting an electrical signal (in particular of analog type), available outside the acoustic transducer.

In the acoustic transducer of FIG. 1, an air cushion separates the membrane 3 and the plate 5. This cushion is squeezed due to the acoustic pressure P, creating a “squeeze film damping” phenomenon, partially counteracted by the presence of the holes 6 in the plate 5.

However, the plate 5 and the holes 6 represent points of resistance to the acoustic flow.

The squeeze film damping and acoustic flow resistance phenomena (depending, inter alia, on the thickness of the air cushion, the total area of the holes 6, the thickness of the plate 5, the dimensions and the number of holes 6) are noise sources which worsen the performances of the acoustic transducer.

To solve the problem of these noise sources and improve the signal-to-noise ratio, various measures have been studied, including for example optimal positioning and shape of the holes 6. Furthermore, particular shapes of the detection structures have been proposed so as to obtain cutting, instead of squeezing, movements of the air cushion, without increasing the dimension of the die accommodating the detection structure.

Although these solutions allow noise to be reduced, they do not however allow it to be eliminated or significantly reduced.

Another solution, using a completely different approach, provides for the separation of the membrane in two parts, having one part arranged in a sensitive area, exposed to the acoustic wave, and another part arranged in a detection or transduction area (placed in a non-noisy environment), as shown schematically in FIG. 2.

Here, a die 10 has two chambers: a sound collection chamber 11, placed in the sound collection area, indicated by 10A, and a detection chamber 12, placed in the detection/transduction area, indicated by 10B.

The sound collection chamber 11 is similar to the chamber 2 of the acoustic transducer of FIG. 1 and has one side (here a bottom side) open towards the outside and one side delimited by a sensitive membrane 13.

The detection chamber 12 is a hermetic chamber, placed under vacuum (or in any case at a much lower pressure than the atmospheric pressure) having a transduction part formed there, also here operating in a capacitive manner and therefore provided with a movable electrode 15 facing fixed electrodes 16.

The movable electrode 15 is mechanically coupled to the sensitive membrane 13 through a transmissive system 18 including a joint or hinge 19, which transfers the movement of the sensitive membrane 13 towards the movable electrode 15 but separates the detection chamber 12 from the external environment.

In detail, the joint 19 has a closure membrane 20 arranged in an opening of a wall 21 of the detection chamber 12 so as to hermetically close the latter towards the outside; the closure membrane 20 is flexible and allows the movements and the vibrations of the sensitive membrane 13 to be transmitted to the movable electrode 15.

This solution allows elimination of the viscous damping due to the air cushion of FIG. 1 as well as the thermal noise generated by the holes present in the fixed electrode (plate 5 of FIG. 1).

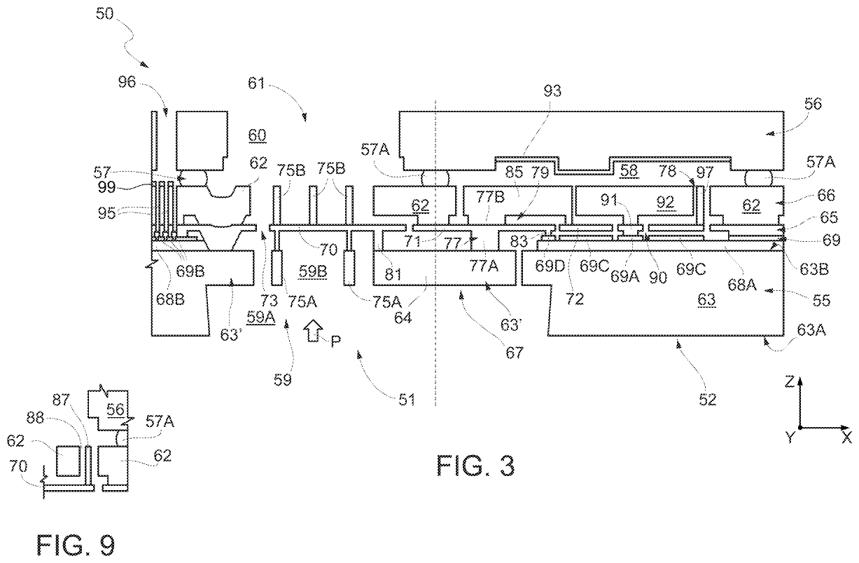

FIG. 3 shows a microphone 50 made using MEMS technology.

The microphone 50 comprises a sound collection part 51 (on the left, in FIG. 3) and a transduction part 52 (on the right, in FIG. 3).

In detail, the MEMS microphone 50 is formed by two dice (first and second die 55 and 56), mutually bonded through adhesive regions 57, for example glass frit regions.

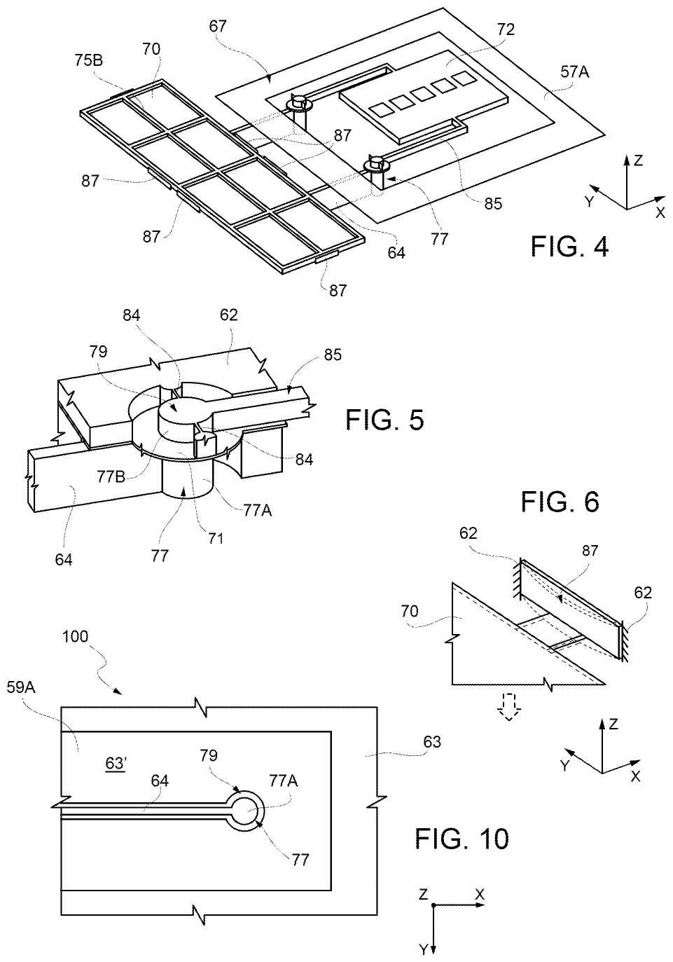

In particular, the adhesive regions 57 comprise a ring region 57A (see also FIG. 4) which allows a transduction chamber 58 to be hermetically closed in the transduction part 52, as discussed in detail below.

The microphone 50 further comprises a rear chamber 59 and a front chamber 60, which are arranged, mutually aligned and one on top of the other, in the sound collection part 51.

The rear chamber 59 and the front chamber 60 form a sound collection chamber 61 and are open to the external environment.

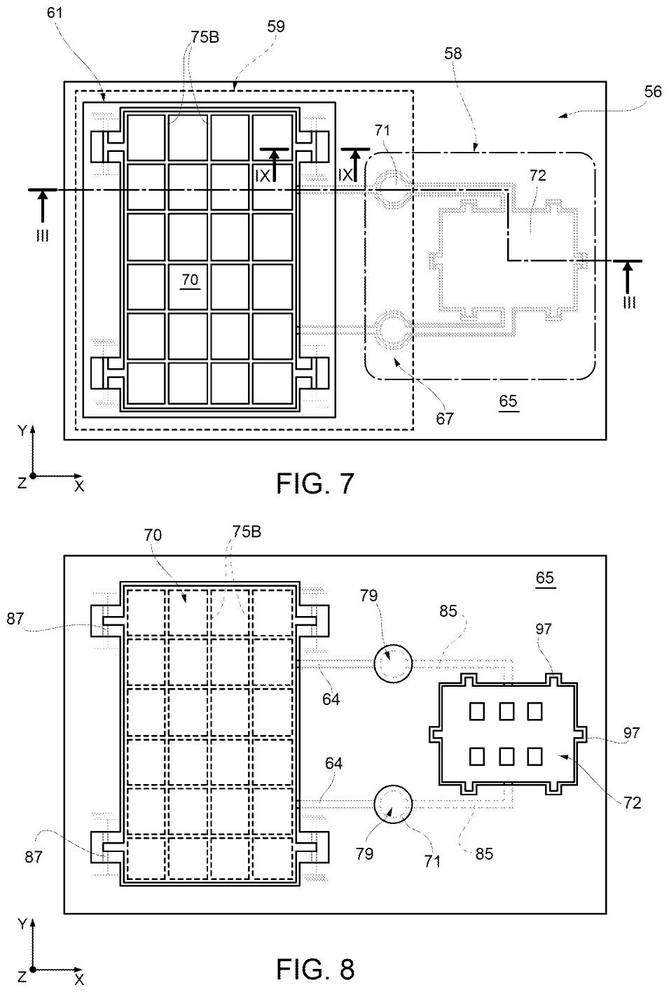

The chambers 58-60 are schematically represented in FIG. 7, highlighting the movable parts of the microphone 50 and their position with respect to the sound collection 51 and transduction parts 52, and in FIG. 8, similar to FIG. 7, but with second die 56 and bottom layers removed.

The first die 55 comprises a substrate region 63 of semiconductor material, typically silicon. The substrate region 63 may have a final thickness equal, for example, to 350 μm, after thinning a semiconductor wafer with a standard thickness of 720 μm, and has a bottom face 63A and a top face 63B.

The substrate region 63 surrounds the rear chamber 59, intended to receive acoustic waves (arrow P).

The rear chamber 59 has a first chamber portion 59A, extending from the bottom face 63A, and a second chamber portion 59B, extending above and in continuation of the first chamber portion 59A.

In the microphone 50, the first chamber portion 59A has an area (in a plane perpendicular to the drawing plane and parallel to a plane XY of a Cartesian reference system XYZ) greater than the second chamber portion 59B and therefore delimits a substrate portion 63′ at the bottom (see also FIG. 10).

In the embodiment shown, first connection arms 64 (only one being visible in FIG. 3, but both arms being visible in FIG. 4) are surrounded by the substrate portion 63′ and extend above the first chamber portion 59A. The first connection arms 64 are formed by the substrate portion 63′ and therefore have a lesser thickness (e.g., about 100 μm) with respect to the rest of the substrate region 63 (e.g., about 350 μm).

The first die 55 further comprises a first epitaxial layer 65, superimposed on the top face 63B of the substrate region 63 (insulated therefrom in some areas by insulating regions, as discussed below) and a second epitaxial layer 66, superimposed on the first epitaxial layer 65.

FIG. 8 shows the configuration of the first epitaxial layer 65, with the second epitaxial layer 66 removed.

The first and the second epitaxial layers 65, 66 are patterned, so as to form, together with the substrate region 63 and the second die 56, various structures of the microphone 50. In particular, they form a fixed structure 62, integral with the substrate region 63 and the second die 56, and movable parts, as explained in detail below.

The fixed structure 62 forms the side wall and part of the bottom wall of the transduction chamber 58 which is closed at the bottom by the substrate region 63 and at the top by the second die 56 (which therefore forms a cap region).

In the embodiment shown, a first field insulation region 68A extends between the substrate region 63 and the first epitaxial layer 65, in the transduction part 52 of the microphone 50.

A first buried connection region 69A, one or more bottom fixed electrode regions 69C and conductive portions 69D (all formed in a conductive layer 69, for example of polysilicon) extend selectively above the first field insulation region 68A and between the first epitaxial layer 65, possibly at a distance therefrom, as discussed in detail below.

Furthermore, here, a second field insulation region 68B extends between the substrate region 63 and the first epitaxial layer 65, in the sound collection part 51 of the microphone 50. Second buried connection regions 69B extend selectively above the second field insulation region 68B and between the first epitaxial layer 65. The second buried connection regions 69B are used for example for external connections, as indicated below.

The first epitaxial layer 65 has a variable thickness; in particular, it has reduced thickness portions, forming, inter alia, flexible membranes, and greater thickness portions, forming, inter alia, support structures and parts of the side wall of the transduction chamber 58.

In particular, the reduced thickness portions of the first epitaxial layer 65 form a sensitive membrane 70, at least one closure membrane 71 (here, two closure membranes 71) and a detection membrane 72. The sensitive membrane 70 and the detection membrane 72 are supported by the fixed structure 62, as discussed in detail below.

For example, the reduced thickness portions may have a thickness of about 1 μm.

The sensitive membrane 70 extends into the sound collection part 51 of the microphone 50 and separates the rear chamber 59 (more precisely, the second chamber portion 59B) from the front chamber 60.

In the embodiment shown, the sensitive membrane 70 has a rectangular shape, although it may have any other suitable shape, for example a circular or polygonal shape.

Ventilation holes 73 (also referred to as “roll-off” holes), one of which is visible in

FIG. 3, may be provided in the sensitive membrane 70.

The sensitive membrane 70 here has first and second reinforcement protrusions 75A, 75B. The first reinforcement protrusions 75A are formed from a substrate also forming the substrate region 63 as well as from the first epitaxial layer 65 and extend into the second chamber portion 59B; the second reinforcement protrusions 75B are formed by the second epitaxial layer 66 and extend into the front chamber 60.

The sensitive membrane 70 is peripherally supported by first anchoring laminas 87 (not visible in FIG. 3) formed in the second epitaxial layer 66 and extending into first lamina openings 88, as explained in more detail below with reference to FIG. 9.

The first connection arms 64 form part of an articulated structure 67 which connects the sensitive membrane 70 to the detection membrane 72 and comprises, in addition to the first connection arms 64, hinge elements 79 and second connection arms 85.

The first connection arms 64 have, as mentioned, a smaller thickness with respect to the substrate region 63 (for example 100 μm) and are directed here substantially parallel to a first horizontal axis X of the Cartesian reference system XYZ; furthermore, they have a reduced width in a direction perpendicular to the sheet plane, parallel to a second horizontal axis Y of the Cartesian reference system XYZ.

The first connection arms 64 are connected to a peripheral portion of the sensitive membrane 70 through a respective vertical connection portion 81 formed in the first epitaxial layer 65.

Each hinge element 79 extends into an intermediate area between the sound collection part 51 and the transduction part 52 of the microphone 50 and comprises a respective closure membrane 71 and a respective pivot element 77.

In detail, each closure membrane 71 (which generally has a much smaller area than the sensitive membrane 70 and the detection membrane 72, differently from what has been shown in

FIG. 3, see FIGS. 7, 8) extends above the first chamber portion 59A and is fixed to a respective first connection arm 64 through the respective pivot element 77.

The pivot elements 77 here have a cylindrical shape (FIGS. 4 and 5).

In particular, here, the pivot elements 77 have a bottom portion 77A and a top portion 77B.

The bottom portion 77A of the pivot elements 77 is here formed in the first epitaxial layer 65, is integral with the closure membrane 71 and extends between the same closure membrane 71 and the respective connection arm 64.

The top portion 77B is formed in the second epitaxial layer 66 and extends between the closure membrane 71 and a respective second connection arm 85.

Furthermore, here, each pivot element 77 is arranged centrally to the respective closure membrane 71; this may for example have a circular or regular polygonal shape, but other shapes/configurations are possible.

Each closure membrane 71 is peripherally fixed to the fixed structure 62 (FIG. 3).

As visible in FIG. 5, the top portions 77B of the pivot elements 77 are also coupled to the fixed structure 62 through thin sections 84 formed in the first epitaxial layer 65.

Furthermore, the closure membranes 71 are coupled, on one peripheral portion thereof close to the detection membrane 72 and on the bottom side thereof facing the substrate region 63, to conductive portions 69D of the conductive layer 69 through first connection portions 83, formed in the first epitaxial layer 65. In this manner, the sensitive membrane 70, the closure membranes 71 and the detection membrane 72 are electrically connected to the potential of the conductive portions 69D (generally, at 0 V).

The second connection arms 85 are formed in the second epitaxial layer 66 and extend within the transduction chamber 58 between the respective top portion 77B and the detection membrane 72. The second connection arms 85 are coupled to the detection membrane 72 at two opposite sides thereof, as visible in FIGS. 7 and 8.

In practice, during operation, the hinge elements 79 of FIG. 5 (which may rotate around an axis perpendicular to the drawing plane, substantially parallel to the second axis Y of the Cartesian coordinate system) transfer the vertical movement (substantially parallel to the vertical axis Z of the Cartesian coordinate system XYZ) of the sensitive membrane 70 in a first direction (for example downwards) into a vertical movement of the detection membrane 72 in the opposite direction, maintaining the hermeticity of the transduction chamber 58.

The detection membrane 72 is coupled to the fixed structure 62 by means of a plurality of second anchoring laminas 97 formed in second lamina openings 98 of the second epitaxial layer 66 (see also FIGS. 4, 7 and 8), as explained below.

In the embodiment shown, the detection membrane 72 has a rectangular shape (although other shapes are possible), and smaller area than the sensitive membrane 70. In this manner, the sensitive membrane 70 has a wide area exposed to an external acoustic wave; the detection membrane 72, on the other hand, has an area which may be designed so as to have a capacitance value (e.g., 1 pF) compatible with the processing circuits provided (for example, an ASIC—Application Specific Integrated Circuit).

The detection membrane 72 here has a plurality of through holes 90 (in FIG. 3, for simplicity of illustration, only one is shown, and in FIGS. 4 and 7 a greater number is shown; in general, the number of through holes 90 may vary from one to several).

Legs/joints 91 (of FIG. 3), formed in part by the first epitaxial layer 65 and in part by the second epitaxial layer 66, extend each through a respective hole 90 and are fixed to the substrate region 63 through one of the first buried connection regions 69A and the first field insulation region 68A.

The legs 91 are integral, at the top, with a top fixed electrode region 92 overlying the detection membrane 72 and therefore capacitively coupled thereto. In this manner, the movements of the detection membrane 72 may be detected as capacitance variations between the same detection membrane 72 and the top fixed electrode region 92 and converted into electrical signals supplied outwardly through the legs 91 and the first buried connection region 69A.

The top fixed electrode region 92 is formed in the second epitaxial layer 66; is adjacent to the second connection arms 85 and has a thickness approximately equal thereto, for example 17 μm.

The bottom fixed electrode regions 69C may be here a second fixed electrode, facing the detection membrane 72 and capacitively coupled thereto.

The second die 56, which as mentioned closes the transduction chamber 58 at the top, has, in the sound collection part 51, an opening forming the top part of the front chamber 60 and therefore directly facing the sensitive membrane 70.

Getter regions 93 are formed on the bottom surface of the second die 56, arranged facing the transduction chamber 58, to ensure a low-pressure atmosphere (vacuum) there.

FIG. 3 also shows external contact structures in the sound collection part 51 of the microphone 50. In detail, here, the first and the second epitaxial layers 65, 66 are etched, so as to form pillars 95 in electrical contact with respective second buried connection regions 69B. Metal contact regions 99 extend on the top surface of the pillars 95, which are accessible from the outside through one or more contact openings 96, formed in the second die 56.

The first anchoring laminas 87 (see FIGS. 4, 6, 8 and 9) are formed, as indicated above, in the second epitaxial layer 66 and extend from the periphery of the sensitive membrane 70, integral therewith. For example, the first anchoring laminas 87 may be provided on the long sides of the sensitive membrane 70.

The first anchoring laminas 87 extend (at rest) substantially parallel to a vertical plane (here the vertical plane YZ of the Cartesian coordinate system XYZ), have a longitudinal extension substantially parallel to the respective side of the sensitive membrane 70 (here at the second horizontal axis Y) and are constrained at their longitudinal ends so as to be able to deform, by twisting, when an acoustic pressure P acts on the sensitive membrane 70, allowing only a vertical movement to the latter.

The second anchoring laminas 97 (FIG. 3) have a shape similar to the first anchoring laminas 87, extend here on all sides of the transduction or detection membrane 72 (FIG. 8) and allow only a vertical movement of the transduction membrane 72.

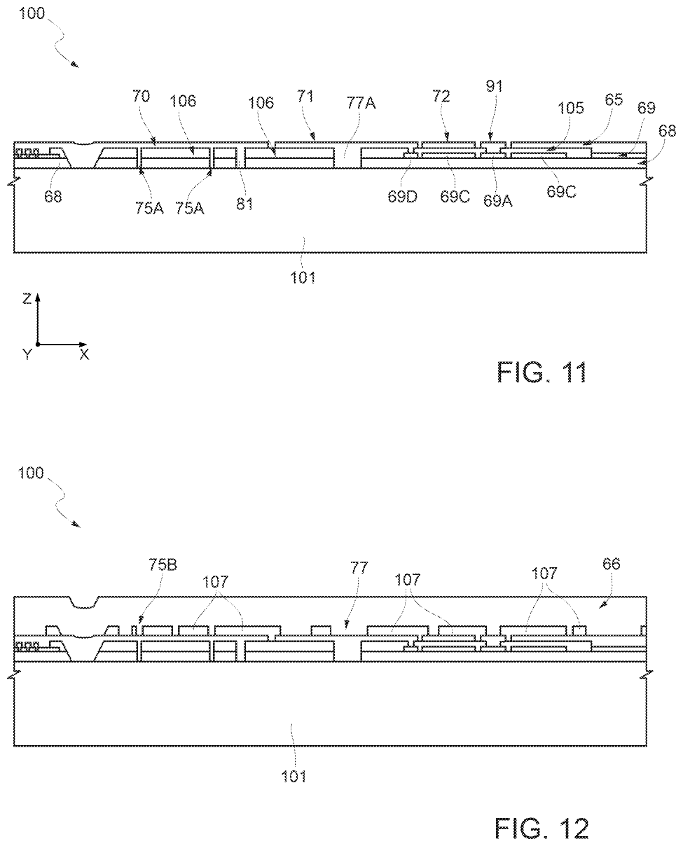

The microphone 50 may be manufactured as described below with reference to FIGS. 11-18, taken on section planes similar to FIG. 3.

The manufacturing process is based on the principles discussed in US Publication No. 2021/0363000.

Furthermore, in FIGS. 11-18, to facilitate the understanding, the various structures shown have been indicated using the same reference numbers as the final microphone 50, except where it is necessary to distinguish the structures in a same layer.

FIG. 11 shows a first wafer 100 after some processing steps have already been performed.

In detail, the first wafer 100 (intended to form the first die 55 of FIG. 3) comprises a substrate 101 of semiconductor material, for example crystalline silicon (having, for example, a final thickness of 350 μm); a field insulation layer 68, having for example a thickness from 0.5 to 3.5 μm, in particular 1 μm, is formed thereon, for example thermally grown.

A conductive layer 69, for example of polycrystalline silicon, already patterned so as to form the regions and portions 69A-69D, extends here above the field insulation layer 68.

An insulating layer 105, for example of TEOS (tetra-ethyl-ortho-silicate) with a thickness for example of 0.5-3 μm, for example 1.5 μm, extends above the field insulation layer 68 and the regions and portions 69A-69D of the conductive layer 69. The insulating layer 105 has been patterned (together with the field insulation layer 68) to form, inter alia, first sacrificial regions 106. The first and the second field insulation regions 68A, 68B have also been defined in the field insulation layer 68, during etch for patterning the sacrificial regions 106.

The insulating layer 105 is also selectively removed above the first buried connection region 69A where the legs 91 are desired to be formed (FIG. 3) and above some of the bottom fixed electrode regions 69C (one is shown in FIG. 11).

The first epitaxial layer 65 is already present, above the insulating layer 105, obtained by epitaxial growth of semiconductor material, for example silicon, and therefore largely of polycrystalline type.

The first epitaxial layer 65 may be grown to have a suitable thickness and then planarized, for example by CMP (Chemical-Mechanical Polishing), so as to have, for example, a thickness of 1 μm above the sacrificial regions 106 where it is desired to form the membranes 70-72 (not yet completely defined).

The first epitaxial layer 65 also extends into the openings of the insulating layer 105 and of the field insulation layer 68, and is here in direct mechanical and electrical contact with the substrate 101 where it forms, inter alia, the bottom portion 77A of the pivot element 77 and other structures (including parts of the first protrusions 75A, the vertical connection portions 81 and portions of the pillars 95).

Furthermore, the first epitaxial layer 65 has already been etched and selectively removed to separate the transduction membrane 72 from the legs 91 supporting the top fixed electrode region 92 as well as from the closure membrane 71.

In FIG. 12, second sacrificial regions 107 are formed on the first epitaxial layer 65. The second sacrificial regions 107 are formed for example by depositing an insulating layer, for example of TEOS, then patterned using a common masked etching process, so as to form openings which expose the surface of the first epitaxial layer 65 in some points. The second sacrificial regions 107 may have, for example, a thickness of 0.5-3 μm.

The second epitaxial layer 66 is formed above the sacrificial regions 107, and has for example a complete thickness of 20 μm (in the areas directly overlying the first epitaxial layer 65). The second epitaxial layer 66 is also obtained by epitaxial growth of semiconductor material, for example silicon, and is therefore substantially of polycrystalline type.

The second epitaxial layer 66 is in direct contact (electrical and mechanical) with the first epitaxial layer 65 at the openings between the second sacrificial regions 107, to form the double thickness regions, including, in this embodiment, the pivot element 77, the side walls of the transduction chamber 58, and the second reinforcement protrusions 75B.

The second epitaxial layer 66 is polished for example by CMP (Chemical Mechanical Polishing) so as to have a flat top surface.

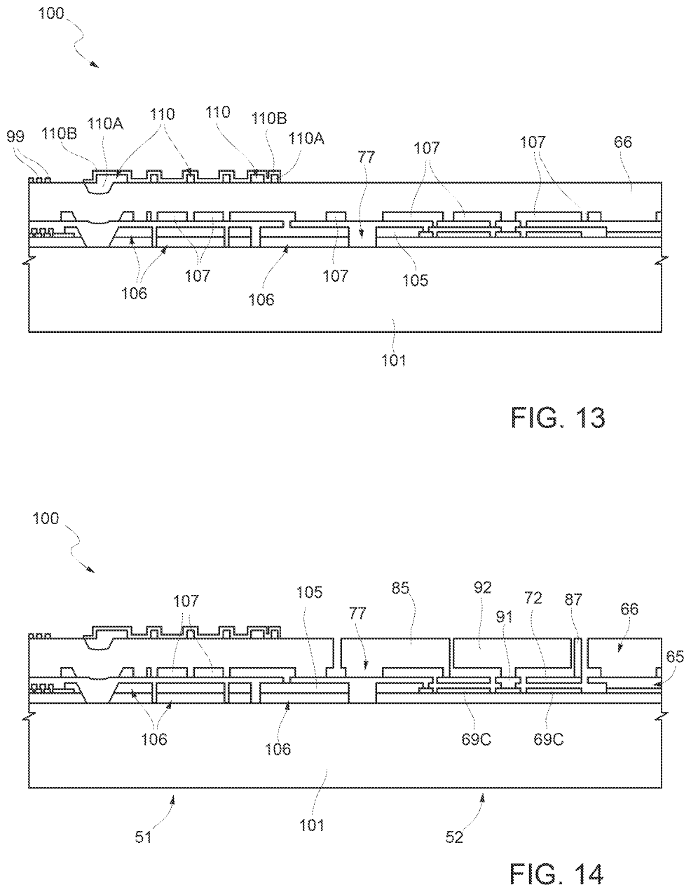

In FIG. 13, a structure definition mask 110 is formed, on the first wafer 100, above the second epitaxial layer 66. For example, the structure definition mask 110 is a hard mask formed by a plurality of layers including a “hard” oxide layer 110A and a protective layer 110B.

The protective layer 110B is, for example, of polycrystalline silicon or silicon carbide or silicon nitride.

In FIG. 13, before or after forming the structure definition mask 110, a metal layer, for example of Al or AlCu, is also deposited and defined on the second epitaxial layer 66 for forming the metal contact regions 99.

In FIG. 14, the first wafer 100 is etched from the front, using an etching mask not shown, so as to define and free some structures in the first and the second epitaxial layers 65, 66, in the transduction part 52.

In particular, by a silicon deep etch of the second epitaxial layer 66, the top fixed electrode region 92, the second connection arms 85 and the second anchoring laminas 97 (for suspending the detection membrane 72) are defined. In this step, the first lamina openings 88 and the first anchoring laminas 87 (not visible in FIG. 14) are also formed.

Furthermore, an etch is performed of the oxide regions that are now accessible, arranged between the second and the first epitaxial layers 66, 65 and below the first epitaxial layer 65. For example, an HF, vapor phase etch is performed.

In particular, in this step, the second sacrificial regions 107 arranged in the transduction part 52, below the second connection arms 85, are removed, freeing them, as well as the second sacrificial regions 107 arranged below the top fixed electrode region 92, separating it from the detection membrane 72.

Furthermore, portions of the insulating layer 105 below the detection membrane 72 are also removed, freeing and separating the latter from the bottom fixed electrode regions 69C. Furthermore, the detection membrane 72 is separated from the legs 91 supporting the top fixed electrode region 92.

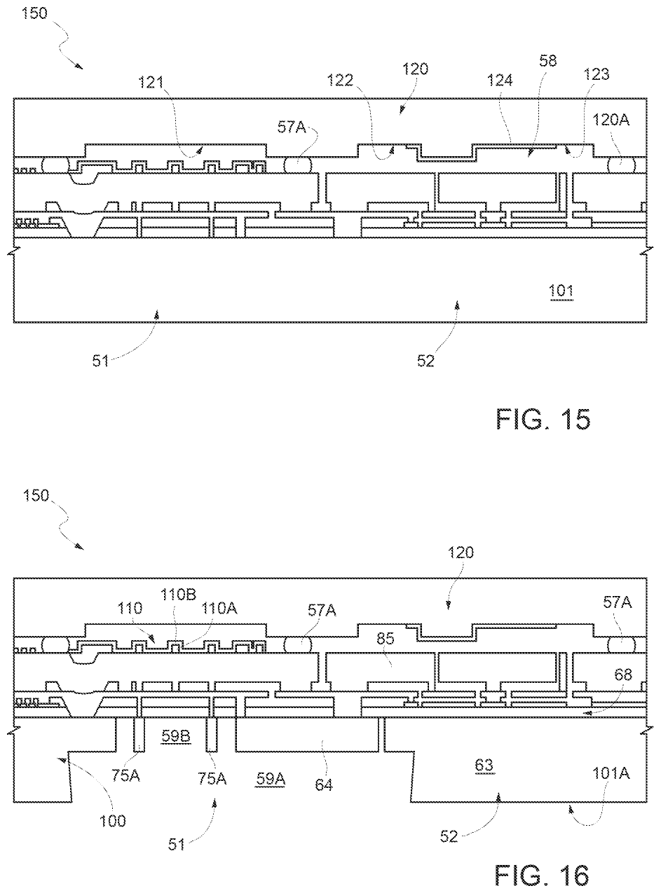

In FIG. 15, the first wafer 100 is fixed to a cap wafer 120, forming a composite wafer 150.

The cap wafer 120 (intended to form the second die 56) is for example a wafer of semiconductor material, such as silicon, of standard thickness and has already been processed on one face thereof (in FIG. 15, bottom face 120A of the cap wafer 120) intended to couple with the first wafer 100.

In particular, the cap wafer 120 has already been selectively etched so as to form a sound collection cavity 121 (intended to form part of the front chamber 60 of FIG. 3), one or two transmission cavities 122 (arranged after bonding on the second connection arms 85), and a transduction cavity 123 (arranged after bonding above the top fixed electrode region 92 and forming part of the transduction chamber 58).

A getter layer 124 has been deposited on part of the bottom face 120A of the cap wafer 120, in the transduction part 52.

Bonding of the cap wafer 120 to the first wafer 100 is here carried out through the adhesive regions 57, for example of glass frit, in a very low-pressure environment (vacuum).

The adhesive regions 57 comprise, inter alia, the ring region 57A which surrounds the transduction chamber 58 and seals it with respect to the outside.

After bonding the cap wafer 120 to the substrate 101, the latter is thinned.

In FIG. 16, the cap wafer 120 is also thinned, for example using a grinding process, up to a thickness of, for example, 150 μm.

Furthermore, the back of the composite wafer 150 is processed, removing selective portions of the substrate 101.

In particular, two etches are carried out using two different substrate masks (not shown) of different types.

For example, a first substrate mask (of hard type, of oxide) is first formed for defining the first chamber portion 59A and then a second substrate mask (for example of resist) is formed for defining the underlying structures.

Subsequently, in a first etch, for example of deep type, and in presence of both substrate masks, not shown, starting from the bottom face 101A of the substrate 101, portions of the substrate 101 are selectively removed, until the field insulation layer 68 is reached. The shape of the first connection arms 64 and the bottom portions of the first reinforcement protrusions 75A (forming the second chamber portion 59B) is thus defined.

Then, after removing the second substrate mask (not shown) and using the first substrate mask (not shown, but having a window with greater area than the first substrate mask), a time deep etch is carried out, which removes only one part of the thickness of the substrate 101, forming the first chamber portion 59A and reducing the thickness of the first connection arms 64 and the bottom portions of the first reinforcement protrusions 75A.

For example, the time etch is continued so that, in the area overlying the first chamber portion 59A, the substrate 101 has a thickness slightly less than 100 μm.

FIG. 10 shows the first wafer 100 from below, after the etches of FIG. 16, in the area of the right end of one of the first connection arms 64, at the pivot element 79. FIG. 10 also shows the bottom portion 77A of the respective pivot element 77, also defined in this step.

After the etches, the hard masks are removed and the composite wafer 150 is cleaned.

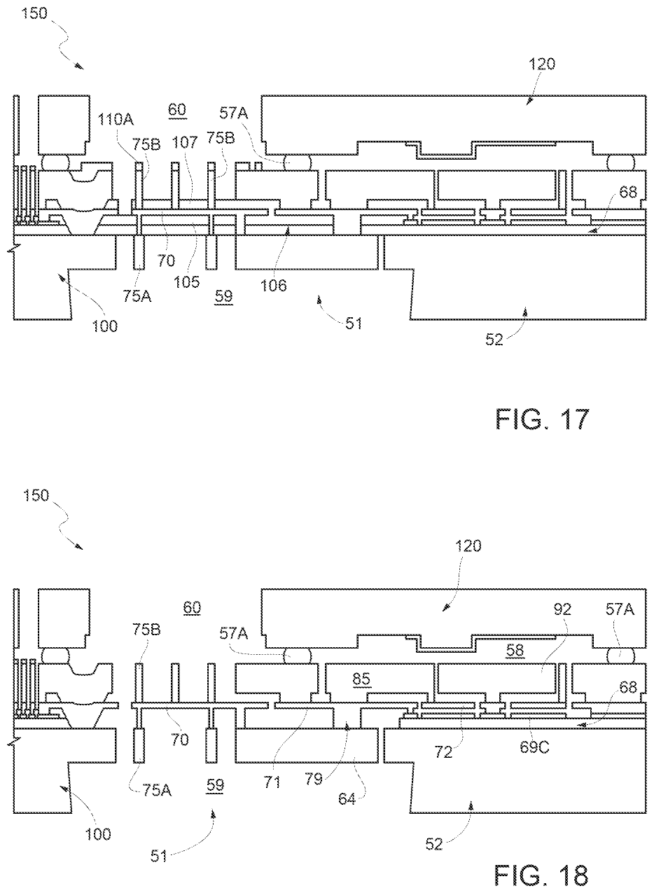

In FIG. 17, the cap wafer 150, the second epitaxial layer 66 and the first epitaxial layer 65 are selectively removed by a front etching step to form the front chamber 60 and to define the second reinforcement protrusions 75B as well as the sensitive membrane 70.

In detail, the cap wafer 150 is etched, by a front silicon deep etch, so as to form the front chamber 60.

Then the protective layer 110B (FIG. 16) is removed and, using the hard oxide layer 110A, the silicon deep etch is continued to remove exposed parts of the second epitaxial layer 66. The etch then continues with the selective removal of the first epitaxial layer 65 (where not covered by the second sacrificial regions 107), forming the second protrusions 75B and defining the sensitive membrane 70.

In FIG. 18, the final release steps are performed.

In detail, the hard oxide layer 110A, the second sacrificial regions 107 and the first sacrificial regions 106 (both their portion formed by the field insulation layer 68 and their portion formed by the insulating layer 105) are removed.

In this manner, the sensitive membrane 70 and the hinge element 79 are completely released.

Then, the final manufacturing steps follow, including dicing the composite wafer 150 to obtain the microphone 50 of FIGS. 3-10, fixing to a support, forming external connection structures (for example wires) and packaging, in a manner known to the person skilled in the art.

The described microphone 50 and manufacturing process thereof have numerous advantages.

In particular, the microphone 50 may be manufactured using industrial processes common in the manufacture of MEMS devices. In particular, the use of a double epitaxial layer process has the following advantages:
avoids using expensive SOIs;
improves the integrability of the microphone, since routing is not formed on the cap (second die 56), but is internal;
considerably reduces manufacturing costs; and
provides the designer with ample freedom regarding the dimensions of the various parts (thickness, area, etc.), also allowing a separate optimization thereof.

The microphone 50 does not need a doped substrate 101, since the electrical connection structures are formed in the conductive layer 69, which is formed separately, in particular deposited, reducing the costs of the finished product.

Furthermore, the substrate region 63 does not require lapping, since the reduced thickness portions (substrate portion 63′, first connection arms 64) are obtained by selective etch. Therefore, it has high mechanical stability.

The structure described allows to provide, in a simple way, a hermetic transduction chamber, therefore impermeable to liquids and gases as well as to various contaminants (such as dust), as desired in some applications.

Gluing the cap wafer 120 to the first wafer 100 through glass frit adhesive regions allows for low-cost bonding.

Forming the closure membrane 71 in the first epitaxial layer 65 allows optimizing the mechanical and electrical characteristics thereof, so as to obtain the desired flexibility (modulating the yielding) and at the same time ensure, in any case, suitable resistance to stresses, in particular such as to avoid breakdown due to the movement of the pivot 77 with respect to the fixed structure 62. Forming the closure membrane 71 in the first epitaxial layer 65 also allows its compressive/tensile/neutral working mode to be set as desired.

By virtue of the high thickness of the second connection arms 85, they have high stiffness; as a result, they have high mechanical strength and are able to correctly transfer the movement from the hinge element 79 to the transduction membrane 72.

Finally, it is clear that modifications and variations may be made to the acoustic transducer and to the manufacturing process described and illustrated here without thereby departing from the scope of the present disclosure.

For example, the first chamber portion 59A and the second chamber portion 59B might have a similar area, although the presented solution is preferable, as it allows the first connection arms 64 to be formed of an optimal thickness with respect to the function of transducing the movement of the sensitive membrane 70 to the hinge element 79.

The transduction part 52 might have only one fixed electrode, even if the simultaneous presence of the bottom fixed electrode regions 69C and the top fixed electrode region 92 is particularly advantageous, as it allows a differential reading.

In summary, exemplary embodiments of the present acoustic transducer may be summarized as follows:

Example 1. A capacitive, MEMS-type acoustic transducer having a sound collection part (51) and a transduction part (52) and comprising:
a substrate region (63) surrounding a first chamber (59) arranged in the sound collection part (51) and open towards the outside;
a fixed structure (62) coupled to the substrate region (63);
a cap region (56), coupled to the fixed structure (62);
a sensitive membrane (70) in the sound collection part (51), the sensitive membrane being coupled to the fixed structure (62) and having a first face facing the first chamber (59);
a transduction chamber (58) in the transduction part (52), the transduction chamber (58) being delimited by delimiting walls formed by the substrate region (63), the fixed structure (62) and the second die (56) and being hermetically closed;
a detection membrane (72) in the transduction chamber (58), above the substrate region (63);
an articulated structure (67) extending between the sensitive membrane (70) and the detection membrane (72), through the walls of the transduction chamber (58);
at least one fixed electrode (92, 69C) facing the detection membrane (72) and capacitively coupled thereto; and
conductive electrical connection regions (69A, 69C, 69D) extending above the substrate region (63), into the transduction chamber (58), the conductive electrical connection regions being in selective electrical contact with the articulated structure (67) and the at least one fixed electrode (92; 69C).

Example 2. The acoustic transducer according to example 1, wherein the substrate region (63) is formed in a semiconductor substrate (101), the fixed structure (62) is formed by a first epitaxial layer (65) overlying the semiconductor substrate (101) and a second epitaxial layer (66) overlying the first epitaxial layer, wherein the first epitaxial layer (65) forms the sensitive membrane (70) and the detection membrane (72).

Example 3. The acoustic transducer according to the preceding example, wherein the articulated structure (67) comprises a first connection arm (64), a hermetic joint (79) and a second connection arm (85), the first connection arm (64) being formed by the semiconductor substrate (101) and extending between the sensitive membrane (70) and the hermetic joint (79), below the first epitaxial layer (65); the hermetic joint extends through the walls of the transduction chamber (58) and comprises a closure membrane (71) formed by the first epitaxial layer (65) and coupled to the walls of the transduction chamber (58); and the second connection arm (85) extends into the transduction chamber (58), between the hermetic joint (79) and the detection membrane 72, and is formed by the second epitaxial layer 66.

Example 4. The acoustic transducer according to the preceding example, wherein the hermetic joint comprises a pivot element (77) having a portion (77A) extending between the first connection arm (64) and the closure membrane (71) and the first epitaxial layer (65) has a first thickness at the sensitive membrane (70), the closure membrane (71) and the detection membrane (72), and a second thickness, greater than the first thickness, at the portion (77A) of the hermetic joint (79).

Example 5. The acoustic transducer according to any of examples 2-4, wherein the at least one fixed electrode is formed by a conductive region (69C) extending above the substrate region (63) and below the detection membrane (72).

Example 6. The acoustic transducer according to any of examples 2-5, wherein the first chamber (59) comprises a first chamber portion (59A) and a second chamber portion (59B), wherein the first chamber portion (59A) has a greater area than the second chamber portion (59B) and delimits the first connection arm (64) at the bottom and wherein the first connection arm (64) is surrounded by the substrate region 63.

Example 6bis. The acoustic transducer according to any of examples 2-6, wherein in the cap region (56) is coupled to the fixed structure (62) through glass frit regions (57).

Example 6ter. The acoustic transducer according to any of examples 2-6bis, wherein the conductive electrical connection regions (69A, 69C, 69D) are electrically insulated from the substrate region (63).

Example 6quater. The acoustic transducer according to any of the examples 2-6ter, wherein the cap region (56) and the fixed structure (62) surround a second chamber (60) arranged in the sound collection part (51), open towards the outside and aligned with the first chamber (59).

Example 6quinquies. The acoustic transducer according to example 6quater, wherein the sensitive membrane (70) has a second face arranged facing the second chamber (60).

Example 6sexies: The acoustic transducer according to example 6quater, wherein the sensitive membrane (70) is arranged between the first chamber (59) and the second chamber (60).

Example 7. A process for manufacturing a capacitive, MEMS-type acoustic transducer having a sound collection part (51) and a transduction part (52), the process comprising:
forming a substrate region (63) surrounding a first chamber (59) in the sound collection part (51) and open towards the outside;
forming a fixed structure (62) coupled to the substrate region (63);
forming a cap region (56), coupled to the fixed structure;
forming a sensitive membrane (70) in the sound collection part (51), the sensitive membrane being elastically coupled to the fixed structure (62) and having a first face arranged facing the first chamber (59),
forming a transduction chamber (58) in the transduction part (52), the transduction chamber (58) being delimited by delimitation walls formed by the substrate region (63), the fixed structure (62) and the second die (56) and being hermetically closed;
forming a detection membrane (72) in the transduction chamber (58), above the substrate region;
forming an articulated structure (67) extending between the sensitive membrane (70) and the detection membrane (72), through the delimitation walls of the transduction chamber (58);
forming at least one fixed electrode (92; 69C) facing the detection membrane (72) and capacitively coupled thereto; and
forming conductive electrical connection regions (69A, 69C, 69D) extending above the substrate region (63), in the transduction chamber (58), the conductive electrical connection regions being in selective electrical contact with the articulated structure (67) and the at least one fixed electrode (92; 69C).

Example 8. The process according to the preceding example, comprising:
arranging a semiconductor substrate (101);
forming first sacrificial regions (106) on the semiconductor substrate;
forming a first epitaxial layer (65) in direct contact with the semiconductor substrate (101), where exposed, and on the first sacrificial regions (105);
defining the first epitaxial layer (65) to form the sensitive membrane (70) and the detection membrane (72);
forming second sacrificial regions (107) on the first epitaxial layer (65);
forming a second epitaxial layer (66) in direct contact with the first epitaxial layer, where exposed, and on the second sacrificial regions (107);
defining the second epitaxial layer (66) to form the fixed structure (62);
removing the second sacrificial regions (107) in the transduction part (52), thereby freeing the detection membrane (72);
hermetically coupling a cap wafer (120) to the fixed structure (62), forming the transduction chamber (58);
selectively removing the semiconductor substrate (101), thereby forming the substrate region (63) and defining the first chamber (59);
selectively removing the cap wafer (120) and the second epitaxial layer (66), thereby forming the cap region (56); and
removing the first sacrificial regions (106) and the second sacrificial regions (107) in the sound collection part (51), thereby freeing the sensitive membrane (70).

Example 9. The process according to the preceding example, wherein:
forming a first epitaxial layer (65) comprises forming a hermetic joint (79) element,
selectively removing the semiconductor substrate (101) comprises defining a first connection arm (64) extending between the sensitive membrane (70) and the hermetic joint (79),
removing the first sacrificial regions (106) in the sound collection part (51) further comprises freeing the hermetic joint (79),
defining the second epitaxial layer (66) comprises forming a second connection arm (85) extending into the transduction chamber, between the hermetic joint (79) and the detection membrane (72),
the first connection arm (64), the hermetic joint (79) and the second connection arm (85) forming the articulated structure (67).

Example 10. The process according to the preceding example, wherein forming a hermetic joint (79) comprises forming a pivot element (77) and a closure membrane (71), the closure membrane (71) extending above one of the sacrificial regions (106), the pivot element (77) extending above and in contact with the semiconductor substrate (101).

Example 11. The process according to example 9 or 10, wherein selectively removing the semiconductor substrate (101) comprises carrying out a thickness etch etching a part of the thickness of the semiconductor substrate (101) to form a first chamber portion (59A) and carrying out a definition etch to form a second chamber portion (59B) and define the first connection arm (64), wherein the first chamber portion (59A) has greater area than the second chamber portion (59B).

Example 12. The process according to any of examples 8-11, wherein forming conductive electrical connection regions (69A-69D) comprises forming an insulating region (68) above the semiconductor substrate (101), forming an electrically conductive layer (69) above the insulating region and defining the electrically conductive layer (69).

Example 13. The process according to the preceding example, wherein the electrically conductive layer (69) comprises doped polycrystalline silicon.

Example 14. The process according to any of examples 8-13, wherein forming conductive electrical connection regions (69A-69D) comprises forming the at least one fixed electrode (69C).

Example 15. The process according to any of examples 8-13, wherein defining the second epitaxial layer (66) comprises forming the at least one fixed electrode (92).

Example 16. The process according to any of examples 8-15,wherein selectively removing the cap wafer (120) comprises forming a second chamber (60) arranged in the sound collection part (51), open towards the outside and aligned with the first chamber (59).

A capacitive, MEMS-type acoustic transducer having a sound collection part (51) and a transduction part (52) and may be summarized as including: a substrate region (63) surrounding a first chamber (59) arranged in the sound collection part (51) and open towards the outside; a fixed structure (62) coupled to the substrate region (63); a cap region (56), coupled to the fixed structure (62); a sensitive membrane (70) in the sound collection part (51), the sensitive membrane being coupled to the fixed structure (62) and having a first face facing the first chamber (59); a transduction chamber (58) in the transduction part (52), the transduction chamber (58) being delimited by delimiting walls formed by the substrate region (63), the fixed structure (62) and the second die (56) and being hermetically closed; a detection membrane (72) in the transduction chamber (58), above the substrate region (63); an articulated structure (67) extending between the sensitive membrane (70) and the detection membrane (72), through the walls of the transduction chamber (58); at least one fixed electrode (92, 69C) facing the detection membrane (72) and capacitively coupled thereto; and conductive electrical connection regions (69A, 69C, 69D) extending above the substrate region (63), into the transduction chamber (58), the conductive electrical connection regions being in selective electrical contact with the articulated structure (67) and the at least one fixed electrode (92; 69C).

The substrate region (63) may be formed in a semiconductor substrate (101), the fixed structure (62) may be formed by a first epitaxial layer (65) overlying the semiconductor substrate (101) and a second epitaxial layer (66) overlying the first epitaxial layer, wherein the first epitaxial layer (65) may form the sensitive membrane (70) and the detection membrane (72).

The articulated structure (67) may include a first connection arm (64), a hermetic joint (79) and a second connection arm (85), the first connection arm (64) being formed by the semiconductor substrate (101) and extending between the sensitive membrane (70) and the hermetic joint (79), below the first epitaxial layer (65); the hermetic joint extends through the walls of the transduction chamber (58) and may include a closure membrane (71) formed by the first epitaxial layer (65) and coupled to the walls of the transduction chamber (58); and the second connection arm (85) extends into the transduction chamber (58), between the hermetic joint (79) and the detection membrane 72, and is formed by the second epitaxial layer 66.

The hermetic joint may include a pivot element (77) having a portion (77A) extending between the first connection arm (64) and the closure membrane (71) and the first epitaxial layer (65) has a first thickness at the sensitive membrane (70), the closure membrane (71) and the detection membrane (72), and a second thickness, greater than the first thickness, at the portion (77A) of the hermetic joint (79).

The at least one fixed electrode may be formed by a conductive region (69C) extending above the substrate region (63) and below the detection membrane (72).

The first chamber (59) may include a first chamber portion (59A) and a second chamber portion (59B), wherein the first chamber portion (59A) may have a greater area than the second chamber portion (59B) and may delimit the first connection arm (64) at the bottom and wherein the first connection arm (64) is surrounded by the substrate region 63.

A process for manufacturing a capacitive, MEMS-type acoustic transducer having a sound collection part (51) and a transduction part (52), the process may be summarized as including:

forming a substrate region (63) surrounding a first chamber (59) in the sound collection part (51) and open towards the outside; forming a fixed structure (62) coupled to the substrate region (63);

forming a cap region (56), coupled to the fixed structure; forming a sensitive membrane (70) in the sound collection part (51), the sensitive membrane being elastically coupled to the fixed structure (62) and having a first face arranged facing the first chamber (59), forming a transduction chamber (58) in the transduction part (52), the transduction chamber (58) being delimited by delimitation walls formed by the substrate region (63), the fixed structure (62) and the second die (56) and being hermetically closed; forming a detection membrane (72) in the transduction chamber (58), above the substrate region; forming an articulated structure (67) extending between the sensitive membrane (70) and the detection membrane (72), through the delimitation walls of the transduction chamber (58); forming at least one fixed electrode (92; 69C) facing the detection membrane (72) and capacitively coupled thereto; and forming conductive electrical connection regions (69A, 69C, 69D) extending above the substrate region (63), in the transduction chamber (58), the conductive electrical connection regions being in selective electrical contact with the articulated structure (67) and the at least one fixed electrode (92; 69C).

The process may include: arranging a semiconductor substrate (101); forming first sacrificial regions (106) on the semiconductor substrate; forming a first epitaxial layer (65) in direct contact with the semiconductor substrate (101), where exposed, and on the first sacrificial regions (105); defining the first epitaxial layer (65) to form the sensitive membrane (70) and the detection membrane (72); forming second sacrificial regions (107) on the first epitaxial layer (65); forming a second epitaxial layer (66) in direct contact with the first epitaxial layer, where exposed, and on the second sacrificial regions (107); defining the second epitaxial layer (66) to form the fixed structure (62); removing the second sacrificial regions (107) in the transduction part (52), thereby freeing the detection membrane (72); hermetically coupling a cap wafer (120) to the fixed structure (62), forming the transduction chamber (58); selectively removing the semiconductor substrate (101), thereby forming the substrate region (63) and defining the first chamber (59); selectively removing the cap wafer (120) and the second epitaxial layer (66), thereby forming the cap region (56); and removing the first sacrificial regions (106) and the second sacrificial regions (107) in the sound collection part (51), thereby freeing the sensitive membrane (70).

Forming a first epitaxial layer (65) may include forming a hermetic joint (79) element, selectively removing the semiconductor substrate (101) may include defining a first connection arm (64) extending between the sensitive membrane (70) and the hermetic joint (79), removing the first sacrificial regions (106) in the sound collection part (51) may further include freeing the hermetic joint (79), defining the second epitaxial layer (66) may include forming a second connection arm (85) extending into the transduction chamber, between the hermetic joint (79) and the detection membrane (72), the first connection arm (64), the hermetic joint (79) and the second connection arm (85) forming the articulated structure (67).

Forming a hermetic joint (79) may include forming a pivot element (77) and a closure membrane (71), the closure membrane (71) extending above one of the sacrificial regions (106), the pivot element (77) extending above and in contact with the semiconductor substrate (101).

Selectively removing the semiconductor substrate (101) may include carrying out a thickness etch etching part of the thickness of the semiconductor substrate (101) to form a first chamber portion (59A) and carrying out a definition etch to form a second chamber portion (59B) and define the first connection arm (64), wherein the first chamber portion (59A) may have greater area than the second chamber portion (59B).

Forming conductive electrical connection regions (69A-69D) may include forming an insulating region (68) above the semiconductor substrate (101), forming an electrically conductive layer (69) above the insulating region and defining the electrically conductive layer (69).

The electrically conductive layer (69) may include doped polycrystalline silicon.

Forming conductive electrical connection regions (69A-69D) may include forming the at least one fixed electrode (69C).

Defining the second epitaxial layer (66) may include forming the at least one fixed electrode (92).

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An acoustic transducer, comprising:
a sound collection part;
a transduction part;
a substrate region surrounding a first chamber in the sound collection part , the first chamber being in fluid communication with an external environment;
a fixed structure coupled to the substrate region;
a cap region coupled to the fixed structure;
a sensitive membrane in the sound collection part, the sensitive membrane being coupled to the fixed structure and having a first face facing the first chamber;
a transduction chamber in the transduction part, the transduction chamber being delimited by walls of the substrate region, the fixed structure and the cap region and being hermetically closed;
a detection membrane in the transduction chamber, the detection membrane being between the substrate region and the fixed structure;
an articulated structure extending in a first direction between the sensitive membrane and the detection membrane;
at least one fixed electrode facing the detection membrane and capacitively coupled thereto; and
conductive electrical connection regions in the transduction chamber and extending in a second direction, transverse the first direction, between the substrate region and the cap region, the conductive electrical connection regions being in selective electrical contact with the articulated structure and the at least one fixed electrode.

2. The acoustic transducer according to claim 1, wherein the substrate region is a semiconductor substrate, the fixed structure is formed by a first epitaxial layer overlying the semiconductor substrate and a second epitaxial layer overlying the first epitaxial layer, wherein the first epitaxial layer forms the sensitive membrane and the detection membrane.

3. The acoustic transducer according to claim 1, wherein the articulated structure includes:
a first connection arm;
a hermetic joint in the transduction chamber, including a closure membrane formed by the first epitaxial layer and coupled to the fixed structure, the first connection arm extending between the sensitive membrane and the hermetic joint; and
a second connection arm extending in the transduction chamber between the hermetic joint and the detection membrane, and is formed by the second epitaxial layer.

4. The acoustic transducer according to claim 3, wherein the hermetic joint includes a pivot element having a portion extending between the first connection arm and the closure membrane, the detection membrane has a first thickness in the first direction less than a second thickness in the first direction of the portion of the hermetic joint, the sensitive membrane and the closure membrane.

5. The acoustic transducer according to claim 2, wherein the at least one fixed electrode is formed by a conductive region between the substrate region and the detection membrane.

6. The acoustic transducer according to claim 2, wherein the first chamber comprises a first chamber portion and a second chamber portion, wherein the first chamber portion has a greater area than the second chamber portion and delimits the first connection arm surrounded by the substrate region.

7. A process for manufacturing an acoustic transducer, comprising:
forming a substrate region surrounding a first chamber in a sound collection part, the first chamber being in fluid communication with an external environment;
forming a fixed structure coupled to the substrate region;
forming a cap region coupled to the fixed structure;
forming a sensitive membrane in the sound collection part, the sensitive membrane being elastically coupled to the fixed structure and having a first face arranged facing the first chamber,
forming a transduction chamber being hermetically closed in a transduction part, the transduction chamber being delimited by walls formed by the substrate region, the fixed structure and the cap region;
forming a detection membrane in the transduction chamber between the substrate region and the fixed structure;
forming an articulated structure extending in a first direction between the sensitive membrane and the detection membrane;
forming at least one fixed electrode facing the detection membrane and capacitively coupled thereto; and
forming conductive electrical connection regions in the transduction chamber and extending in a second direction, transverse the first direction, between the substrate region and the cap region, the conductive electrical connection regions being in selective electrical contact with the articulated structure and the at least one fixed electrode.

8. The process according to claim 7, further including:
forming first sacrificial regions on a semiconductor substrate that includes the semiconductor region;
forming a first epitaxial layer in direct contact with the semiconductor substrate, where exposed, and on the first sacrificial regions, wherein forming the sensitive membrane and forming the detecting membrane includes defining the first epitaxial layer to form the sensitive membrane and the detection membrane;
forming second sacrificial regions on the first epitaxial layer;
forming a second epitaxial layer in direct contact with the first epitaxial layer, where exposed, and on the second sacrificial regions, wherein forming the fixed structure includes defining the second epitaxial layer to form the fixed structure;
removing the second sacrificial regions in the transduction part, thereby freeing the detection membrane, wherein forming the transduction chamber includes hermetically coupling a cap wafer to the fixed structure to form the transduction chamber;
wherein forming the substrate region includes selectively removing the semiconductor substrate to define the first chamber;
wherein forming the cap region includes selectively removing the cap wafer and the second epitaxial layer; and
removing the first sacrificial regions and the second sacrificial regions in the sound collection part, thereby freeing the sensitive membrane.

9. The process according to claim 8, wherein:
forming the first epitaxial layer includes forming a hermetic joint element;
selectively removing the semiconductor substrate includes defining a first connection arm extending between the sensitive membrane and the hermetic joint;
removing the first sacrificial regions in the sound collection part includes freeing the hermetic joint; and
defining the second epitaxial layer includes forming a second connection arm extending in the transduction chamber between the hermetic joint and the detection membrane, wherein the articulated structure includes the first connection arm, the hermetic joint and the second connection arm.

10. The process according to claim 9, wherein forming the hermetic joint includes forming a pivot element and a closure membrane, one of the sacrificial regions being between the closure membrane and the first connection arm, the pivot element coupled with the semiconductor substrate.

11. The process according to claim 9, wherein selectively removing the semiconductor substrate includes etching the semiconductor substrate to form a first chamber portion and a second chamber portion, wherein etching defines the first connection arm, wherein the first chamber portion has greater area than the second chamber portion.

12. The process according to claim 7, wherein forming conductive electrical connection regions includes:
forming an insulating region on the semiconductor substrate; and
forming an electrically conductive layer on the insulating region.

13. The process according to claim 12, wherein the electrically conductive layer includes doped polycrystalline silicon.

14. The process according to claim 7, wherein forming conductive electrical connection regions includes forming a second fixed electrode.

15. The process according to claim 8, wherein defining the second epitaxial layer comprises forming a second fixed electrode.

16. A device, comprising:
a first semiconductor die;
a second semiconductor die having a first surface coupled to a first surface of the first semiconductor die;
a first open chamber extending through the first semiconductor die and the second semiconductor die, the first open chamber being in fluid communication with an external environment;
a second sealed chamber between the first semiconductor die and the second semiconductor die;
a movable electrode in the second sealed chamber; and
a sensitive membrane extending in the first open chamber and coupled to the moveable electrode.

17. The device of claim 16, comprising an articulated structure coupling the movable electrode with the sensitive membrane, the articulated structure including:
a first connection arm having a first end coupled to the sensitive membrane;
a hinge element coupled to a second end of the first connection arm; and
a second connection arm having a first end coupled to the hinge element, the movable electrode coupled to a second end of the second connection arm, the second connection arm being in the second sealed chamber.

18. The device of claim 16, wherein the first semiconductor die has a protrusion between the first surface and a second opposite surface, the protrusion delimiting a recess in the first semiconductor die, the protrusion having a first surface transverse to the first surface of the first semiconductor die.

19. The device of claim 17, comprising a fixed structure between the first semiconductor die and the second semiconductor die, the fixed structure delimiting the second sealed chamber.

20. The device of claim 16, comprising a getter region on the first surface of the second semiconductor die, the getter region being in the second sealed chamber.
